(19) United States
(12) Patent Application Publication
(10) Pub. No.: US 2010/0011133 A1
(43) Pub. Date: Jan. 14, 2010

(54) INFORMATION PROCESSING APPARATUS, METHOD FOR CONTROLLING ACTIVATION OF CLASS MODULE, AND COMPUTER PROGRAM PRODUCT FOR CARRYING OUT THE METHOD

(76) Inventor: Tomohide TAKANO, Narashino-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/496,152

(22) Filed: Jul. 1, 2009

(30) Foreign Application Priority Data
Jul. 11, 2008 (JP) 2008-181556

(51) Int. Cl. G06F 3/00

(52) U.S. Cl. 710/10; 710/16; 710/300

(57) ABSTRACT

An information processing apparatus including a general-purpose interface connecting external devices to the apparatus; plural plug-in class modules accessing the external devices through the interface to provide the external devices with services; a connection and separation detection module detecting connection or separation of an external device; and a list registration device having an external device information list storing external device information while relating to the class modules, and performing new information registration as needed. The connection and separation detection module includes an external device information obtaining device obtaining information to specify the connected external device; a notified module determining device determining a class module to be notified from the information obtained by the external device information obtaining device and the information stored in the list when detecting connection and separation; and a device information notifying device notifying the corresponding class module about the information on the connected external device.

### BACKGROUND OF THE INVENTION

1. Field of the Invention

The present invention relates to an information processing apparatus capable of accessing external devices, which can be inserted into and extracted from (connected to and separated from) the apparatus, through a general-purpose interface to provide the external devices with services. More specifically, the present invention relates to an information processing apparatus including plural kinds of plug-in class modules to access external devices. In addition, the present invention also relates to a method of controlling activation of class modules, and a computer program product for carrying out the method of controlling activation of class modules.

2. Discussion of the Background

Recently, personal computers (PCs) are typically equipped with a general-purpose interface such as USB (Universal Serial Bus) so that various kinds of external devices can be connected with the computers.

Such a general-purpose interface has been used for information processing apparatus serving as computer-integrated apparatus such as printers and multifunction products (MFP), and therefore the information processing apparatus can perform exchange of information (such as image information) with external devices. In this regard, the computer-integrated apparatus are defined as apparatus (such as industrial apparatus, office apparatus and home electric appliances) into which a computer typically including a low price CPU and a low capacity memory is integrated to impart specific functions and limited properties thereto.

In such computer-integrated apparatus, a system program such as OS (Operating System) is typically stored in a ROM (Read Only Memory), and therefore it is not easy to change the structure of the system of the apparatus. Accordingly, even when the apparatus are equipped with a general-purpose interface, a problem in that a driver for an external device, which can operate in a predetermined OS, cannot be loaded therein is often caused because the structure of the OS, etc., cannot be changed. In addition, a problem in that only limited drivers can be loaded in the apparatus due to the memory capacity thereof occurs. In contrast, in the case of PCs, the adopted OS has versatility, and a number of drivers applicable to the OS are provided therein. In addition, PCs have large memory capacity, and therefore any drivers for new external devices can be installed to be used therefor. Therefore, PCs do not cause the above-mentioned problems caused in such computer-integrated apparatus.

Thus, only limited external devices can be connected to the general-purpose interface of computer-integrated apparatus. Namely, the interface of computer-integrated apparatus is used only for specific external devices, and the versatility thereof cannot be effectively used.

In addition, conventional computer-integrated apparatus do not often have a device, which informs a user such that the external device of the user cannot be used for the interface of the computer-integrated apparatus, and thereby a problem in that the user is bewildered thereby is caused.

Because of these reasons, a need exists for an information processing apparatus, which uses a computer having limited properties but has a convenience such that various kinds of external devices connected to and separated from the apparatus through a general-purpose interface can be used therefor without change of structure of the OS thereof or installation of an additional driver therein.

### SUMMARY OF THE INVENTION

As an aspect of the present invention, an information processing apparatus is provided, which includes:

a general-purpose interface configured to connect connectable and separable external devices to the information processing apparatus;

plural plug-in class modules configured to access the external devices through the interface to provide the external devices with services;

a connection and separation detection module configured to detect the connection or separation event of an external device; and

a list registration device, which has an external device information list in which information on the external devices is stored while relating the information to the respective class modules and which performs registration of new information in the external device information list as needed.

The connection and separation detection module includes:

an external device information obtaining device configured to obtain information to specify the external device connected to the information processing apparatus;

a notified module determining device, which determines one of the plural class modules as a notified module on the basis of the information obtained by the external device information obtaining device and the information stored in the external device information list when detecting the connection and separation event of the external device; and

a device information notifying device configured to notify the corresponding class module about the information on the connected external device.

As another aspect of the present invention, a method for controlling activation of a class module in an information processing apparatus including plural plug-in class modules configured to access connectable and separable external devices through an interface to provide the external devices with services.

The method includes:

storing new information as needed in an external device information list in which information on the external devices is stored while relating the information to the respective class modules;

detecting a connection or separation event of an external device;

obtaining information to specify the external device connected to the information processing apparatus;

determining one of the plural class modules as a notified module on the basis of the information obtained in the external device information obtaining step and the information stored in the external device information list when detecting the connection and separation event of the external device; and

notifying the corresponding class module about the information on the connected external device.

As yet another aspect of the present invention, a computer program product is provided, which is stored on a computer readable storage medium for carrying out the above-mentioned method.

As a further aspect of the present invention, a computer readable storage medium is provided, which stores computer instructions for performing the method mentioned above.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a block diagram illustrating the hardware construction of an example (multifunction product) of the information processing apparatus of the present invention;

FIG. 2 is a view illustrating the software construction of the multifunction product illustrated in FIG. 1 while relating the software to the hardware thereof;

FIG. 3 is a view illustrating the control system of the multifunction product used when the multifunction product accesses an external device;

FIG. 4 illustrates an example of the data construct of the notification condition list;

FIG. 5 illustrates an example of the data construct of the notification event; and

FIG. 6 is a flowchart illustrating the class module selection control system illustrated in FIG. 3.

### DETAILED DESCRIPTION OF THE INVENTION

The present invention will be explained by reference to drawings.

The information processing apparatus and the method for controlling activation of a class module will be explained by reference to a multifunction product (MFP), which is an example of the information processing apparatus.

The multifunction product has multiple functions such as functions as printer, copier, document box (i.e., function of sending or printing document data stored therein), scanner, facsimile, etc. The multifunction product carries out the functions when receiving an instruction from an operation panel or a request for processing from an external client (host) device.

In addition, the multifunction product has various kinds of interfaces (hereinafter sometimes referred to as I/F) so as to be connected external devices serving as peripheral devices. By exchanging information with the external devices through the interfaces, the information processing apparatus can expand the functions thereof. Particularly, this example of the information processing apparatus is characterized by using a general-purpose interface and having a feature concerning the general-purpose interface.

At first, the abstract of the example (multifunction product) of the information processing apparatus will be explained.

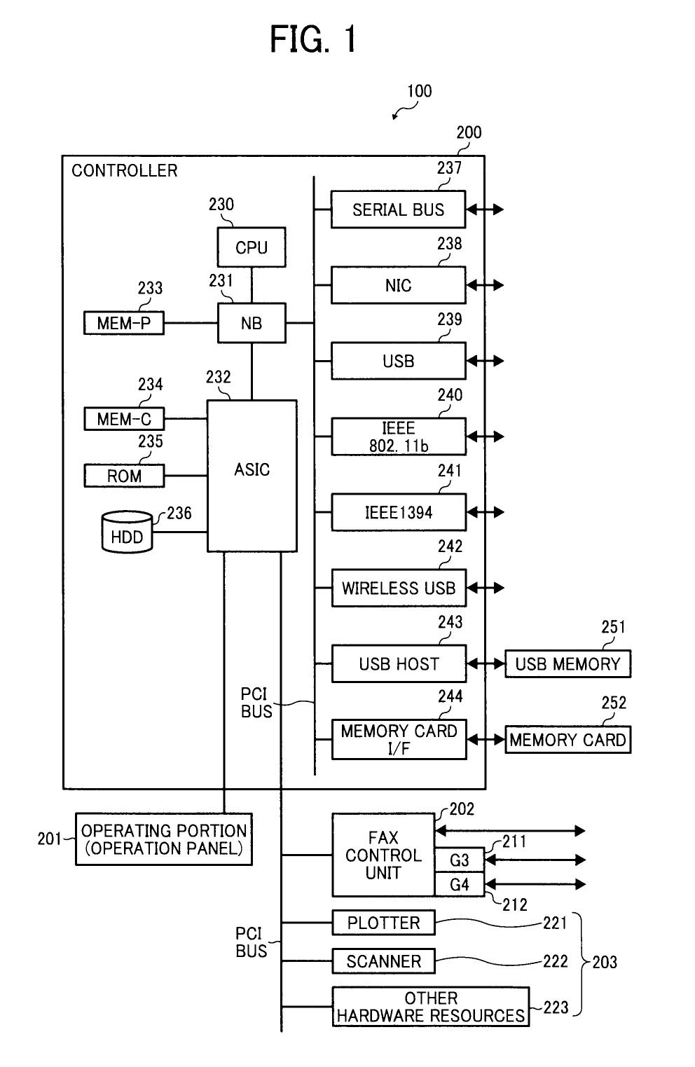

FIG. 1 is a block diagram illustrating the hardware construction of the example (multifunction product) of the information processing apparatus of the present invention. Referring to FIG. 1, a multifunction product 100 includes a controller 200, which constitutes a control system controlling the entire of the multifunction product and which includes a central processing unit (CPU) 230 configured to control a storage portion such as memories, which will be explained later.

Data input/output portions of this multifunction product 100 are as follows. One of the data input/output portions is a scanner 222, which opto-electronically reads an original image and inputs the read data such as image data to be processed.

Another data input/output portion is an operating portion (operation panel) 201. By performing an operation using keys or the like of the operating portion 201, instruction such as setting of operating/processing conditions, inputting of control information and starting of processing can be conducted to the apparatus. In this regard, since the operating portion 201 serves as a user interface, the operating portion also performs an output operation of informing the user of the operating state of the apparatus or making a response to an input operation.

Yet another data input/output portion is a communication interface, which is connected with an external device through a network or is directly connected with an external device and which will be explained later in detail. The multifunction product exchanges data with external devices (such as host computers, facsimiles, and IC cards). In this regard, the data input and output through the communication interface are data to be processed such as image data and control information data (such as information needed for performing a communication operation among devices).

The data such as image data to be processed are printed by a plotter 221.

As illustrated in FIG. 1, the multifunction product 100 has a hardware construction such that the controller 200, the operating portion (operation panel) 201, a fax control unit 202 and a group of engines 203 serves as main units.

The controller 200 includes the CPU 230, an ASIC (Application Specific Integrated Circuit) 232, a system memory (MEM-P) 233, a local memory (MEM-C) 234, a ROM 235, a HDD (Hard Disk Drive) 236, a north bridge 231 (hereinafter sometimes referred to as a NB), a serial bus 237, a NIC (Network Interface Card) 238, a USB (Universal Serial Bus) I/F 239, an IEEE802.11b I/F 240, an IEEE1394 I/F 241, a wireless USB I/F 242, a USB host 243, and a MEMORY CARD I/F 244.

The serial bus 237, NIC (Network Interface Card) 238, USB (Universal Serial Bus) I/F 239, IEEE802.11b I/F 240, IEEE1394 I/F 241, wireless USB I/F 242, USB host 243, and MEMORY CARD I/F 244, which are interfaces with external devices, are connected with the NB 231 through a PCI (Peripheral Component Interconnect) bus.

The operating portion 201 is connected with the ASIC 232 of the controller 200. The fax control unit 202 and the group of engines 203 are connected with the ASIC 232 through the PCI bus.

In this regard, the local memory (MEM-C) 234, ROM 235 and HDD (Hard Disk Drive) 236 are connected with the ASIC 232, and the CPU 230 and the ASIC 232 are connected with each other through the NB 231, which is a CPU chipset. By thus connecting the CPU 230 and the ASIC 232 through the NB 231, no problem occurs even when the interface of the CPU 230 is unknown.

The NB 231 is a bridge for use in connecting the CPU 230, system memory (MEM-P) 233, ASIC 232, and the interfaces, i.e., serial bus 237, NIC (Network Interface Card) 238, USB (Universal Serial Bus) I/F 239, IEEE802.11b I/F 240, IEEE1394 I/F 241, wireless USB I/F 242, USB host 243 and MEMORY CARD I/F 244, which are connected with the NB 231 through the PCI bus.

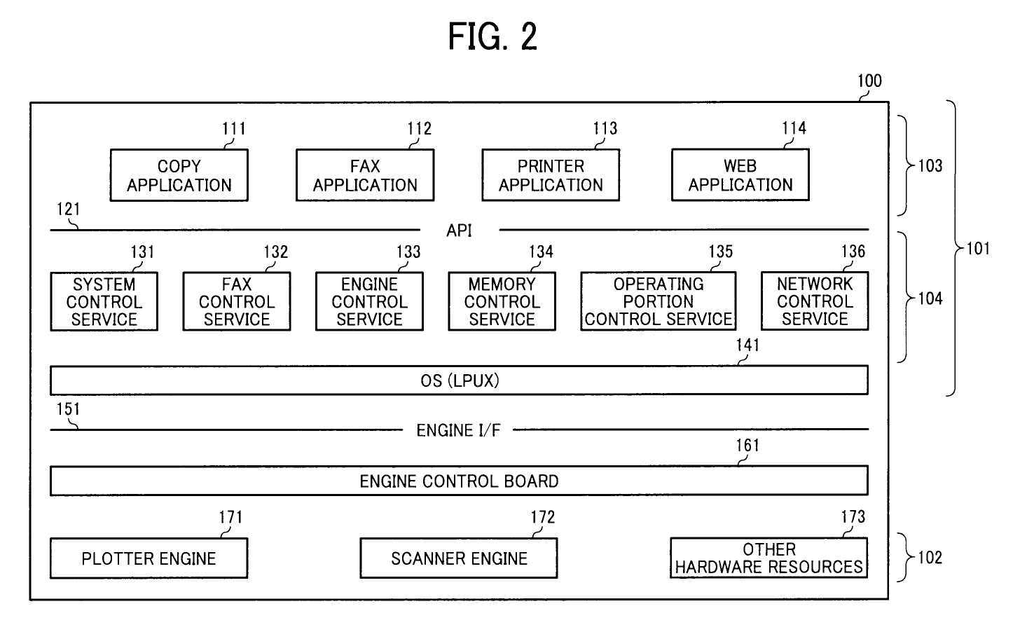

The CPU 230 constitutes a control system for controlling the entire of the multifunction product 100. The software construction of this system will be explained later by reference to FIG. 2.

The system memory (MEM-P) 233 is a memory for use as a draw-use memory of the multifunction product 100. The local memory (MEM-C) 234 is a memory, which can be used as an image-output-use buffer, in which data input from the scanner 222, and print data received from an external host device (not shown) through a communication interface are stored, and a sign buffer. The ROM 235 is a memory in which programs and control data are stored.

The HDD 236 serves as a storage in which image data, document data, font data and form data are stored.

The ASIC 232 is an IC (Integrated Circuit) having a hardware component for use in image processing.

The operating portion 201 is an operation panel including a group of buttons and keys, with which users can perform input operations, and a monitor display showing images for users. In this regard, the operating portion 201 may include a touch panel.

The serial bus 237, NIC (Network Interface Card) 238, USB (Universal Serial Bus) I/F 239, IEEE802.11b I/F 240, IEEE1394 I/F 241, wireless USB I/F 242, USB host 243 and MEMORY CARD I/F 244 are interfaces for connecting the multifunction product 100 with external devices, which adopt respective standards, using a method instructed in the standard of the multifunction product 100. In addition, the USB host 243 is an I/F for connecting a USB memory 251 to the multifunction product 100, and the MEMORY CARD I/F 243 is an I/F for connecting a memory card 252 to the product.

In the example image processing apparatus illustrated in FIG. 1, the USB I/F 239, IEEE1394 I/F 241, wireless USB I/F 242 and USB host 243 are used as general-purpose interfaces. By using such general-purpose interfaces, various kinds of external devices can be connected with the multifunction product 100 and thereby information can be exchanged therebetween, resulting in formation of a cooperative system.

The fax control unit 202 is connected with the PCI bus controlled by the ASIC 232. The fax control unit 202 includes a Group-3 (G3) standard unit 211 meeting the Group-3 (G3) standard, and a Group-4 (G4) standard unit 212 meeting the Group-4 (G4) standard.

The group of engines 203 is connected with the PCI bus controlled by the ASIC 232. The group of engines includes the plotter engine 221 performing print output of image data, etc., the scanner engine 222 reading the image of an original and inputting the read image data, and other hardware resources 223 necessary for the processings and operations of the multifunction product 100.

Next, the structure of the software driven by the CPU 230 will be explained.

FIG. 2 is a view illustrating software construction of the multifunction product 100 while relating the software construction to the hardware resources thereof. The CPU 230 constitutes a control system controlling the entire of the multifunction product 100 by driving the software illustrated in FIG. 2.

As illustrated in FIG. 2, the multifunction product 100 includes a group of software 101 and hardware resources 102. The group of software 101 includes an application layer 103, and a platform layer 104 which receives a processing request from the application layer 103 and generates a request for acquiring a necessary hardware from the hardware resource 102.

As illustrated in FIG. 2, the application layer 103 includes a copy application 111, which is an application for copying, a fax application 112, which is an application for facsimileing, a printer application 113, which is an application for printer, and a web application 114, which is a web application (i.e., weblication).

The web application 114 is a group of applications performing web services using a hyper text transfer protocol (HTTP) implemented in the multifunction product 100. Specifically, the web application 114 makes it possible to check the state of the multifunction product 100 using a browser and to perform a variety of settings of the multifunction product such as network setting.

The platform layer 104 interprets the processing request from each application of the application layer 103 and generates a request for acquiring a necessary hardware from the hardware resource 102 while controlling the acquired hardware resource 102.

The platform layer 104 includes a system control service 131, a fax control service 132, an engine control service 133, a memory control service 134, an operating portion control service 135, and a network control service 136. The system control service 131 has plural functions such as application management, operating portion controlling, system view displaying, LED displaying, resource management, and interruption controlling. The network control service 136 provides services, which can be commonly used for applications needing network inputting and outputting.

In addition, the platform layer 104 includes an API (Application Program Interface) 121, which can receive a processing request from the application layer 103 using a predefined function.

The group of software 101 is run on an OS (LPUX) 141, and thereby various processings are performed. The OS 141 executes in parallel each of the software of the application layer 103 and the platform layer 104 as a process.

An engine I/F 151 makes it possible to send a processing request to the hardware resource 102 through an engine control board 161 using a function predefined by the software of the group of software 101. The engine I/F 151 and the engine control board 161 properly use the software and hardware as a realization device.

The hardware resource 102 illustrated in FIG. 2 includes a plotter engine 171, a scanner engine 172 and other hardware resources 173 as components.

Next, connection with external devices will be explained.

As mentioned above, the multifunction product 100, which is an example of the information processing apparatus of the present invention, includes general-purpose interfaces to be connected with external devices. By using such general-purpose interfaces, information can be exchanged with the external devices, resulting in formation of a cooperative system.

However, even when the multifunction product 100 is physically connected with an external device using a connector or a transceiver, the product cannot perform information exchange unless operations following the necessary communication procedure cannot be performed. In addition, unless the driver corresponding to the connected external device is installed in the multifunction product, the external device cannot be operated.

Conventional computer-integrated apparatus having such a structure as illustrated in FIG. 1 store the OS (LPUX) in a ROM (such as ROM 235 in FIG. 1). Therefore, it is not easy for the apparatus to introduce the necessary communication procedure and device driver. As a result, the general-purpose interfaces are typically used only for special external devices as mentioned above in “Discussion of the Background” of this application.

Therefore, the purpose of this example of the present invention is to make it possible to access various external devices connected and separated through a general -purpose interface even when the resources such as OS and memory of the computer of the apparatus have limitations. In order to achieve the purpose, plural kinds of plug-in software modules are provided so as to be used for operating external devices, and one software module capable of being used for the connected external device is selected from the thus provided software modules. The multifunction product 100 constitutes a control system performing controlling using the selected software module.

In the following control system constructed on the multifunction product (i.e., information processing apparatus) the plural kinds of plug-in software modules are class modules for general-purpose drivers. Namely, by using such class modules, addition and deletion of plural kinds of software modules can be easily performed.

In this example, the information on external devices is previously stored in the external device information list (i.e., a notification condition list mentioned later) while relating the information to the respective class modules corresponding to the external devices. When an external device is connected with the multifunction product through a general-purpose interface, one of the class modules, which can be applied to the connected external device, is determined by reference to the list. Thus, a proper class module is selected among plural class modules so that the multifunction product 100 can correspond to various external devices. Thus, general-purpose drivers, which are entry when accessing external devices using service programs, can be exclusively used.

Next, the class module selection control system will be explained.

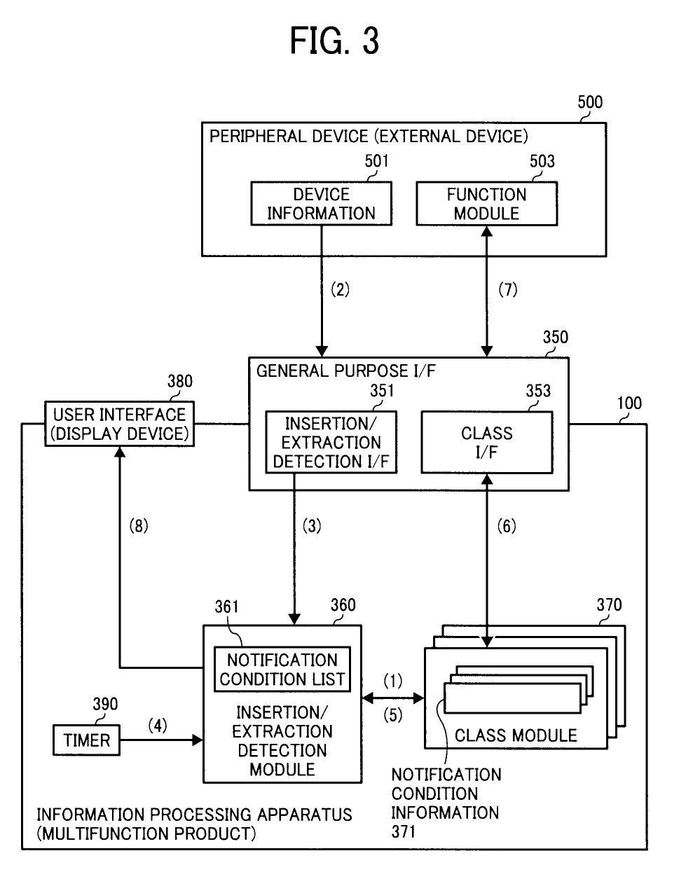

FIG. 3 is a view illustrating a class module selection control system constructed on the multifunction product so that the multifunction product can access an external device. In FIG. 3, arrows indicate flow of information in a series of operations of the system such as registration of a notification condition list, selection of a class module used for connection with an external device, and access to the external device.

The control system illustrated in FIG. 3 includes a class module 370, a general-purpose interface 350 and an insertion/extraction detection module 360 as main components. FIG. 3 illustrates a procedure for allowing a function module 503 of an external device 500 to be used, i.e., a procedure for selecting the class module 370 so that the multifunction product 100 can access the external device 500. In this regard, the external device 500 is one of various kinds of external devices, which can be connected with the multifunction product 100.

The general-purpose interface 350 is an interface receiving a communication request from the external devices connected to the multifunction product 100. Specific examples of the interfaces for use as the general-purpose interface 350 include USB, wireless USB, and IEEE1394, which are illustrated in FIG. 1 and to which different standards are applied.

The class module 370 is an application program (hereinafter sometimes referred to as an application) which accesses the external device 500 connected with the multifunction product 100 through the general purpose interface 350 to provide services. In this example, the class module 370 collects device information 501 concerning the external device 500, and registers the collected information on a notification condition list 361 as notification condition information 371. Therefore, this program is provided.

For example, when the external device 500 is an IC card reader, the class module 370 can access the IC card reader through the general-purpose interface 350. Therefore, services for performing an output processing such as production of certificate copy (print) can be provided on the condition that certification is performed using the information written in the IC card.

The insertion/extraction detection module 360 is a module of watching events of insertion to and extraction from (i.e., connection to and separation from) the general-purpose interface 350 for the external device 500 through an insertion/extraction interface 351. Specifically, when detecting insertion or extraction, the insertion/extraction detection module 360 notifies the class module 370 about the insertion/extraction event (kinds of the insertion/extraction event). In addition, the insertion/extraction detection module 360 notifies the class module 370 of information on the most suitable class module 370 for the connected external device 350. This will be explained later in detail.

In order to select the most suitable class module, it is necessary for the multifunction product 100 to have information on the relationship between information (application information) on the plural kinds of class modules 370 and information on external devices in the form of list or the like. In this example, the insertion/extraction detection module 360 prepares and manages the external device information list in the form of the notification condition list 361.

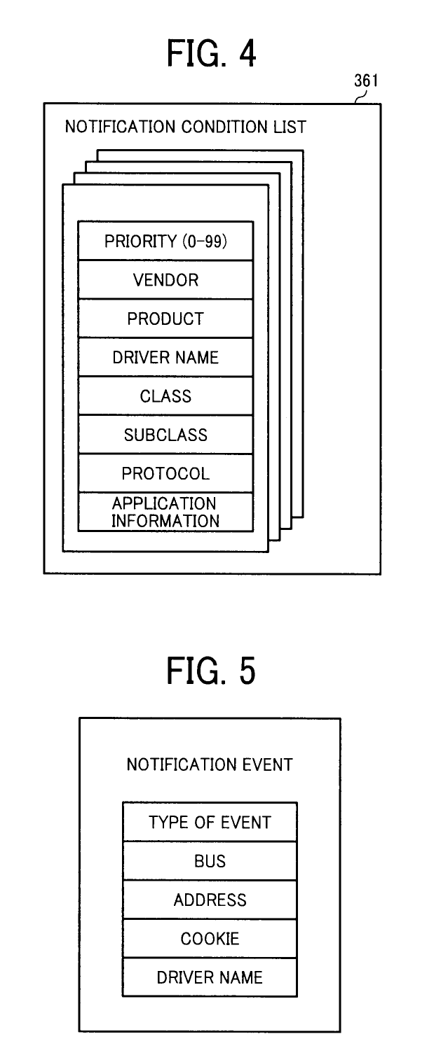

FIG. 4 is a view illustrating an example of the data construction of the notification condition list 361.

As illustrated in FIG. 4, the information listed in the notification condition list 361 includes the application information of the class modules providing services and information for use in specifying peripheral devices (external devices). In this example, the information for use in specifying the external device 500 includes parameters for specifying the external device such as vendor, product, driver name, class, subclass and protocol.

The insertion/extraction detection module 360 determines the most suitable class module for the connected external device 350 among the plural kinds of class modules 370 on the basis of the registered notification condition list 361. Specifically, at first the insertion/extraction detection module 360 obtains the information on the connected external device 350 such as vendor, product, driver name, class, subclass and protocol to compare the information (parameters) with the parameters stored in the notification condition list 361 and selects one of the notification condition lists having the highest consistency. Thus, the insertion/extraction detection module 360 can determine the most suitable class module for the connected external device 350 on the basis of the application information stored in the list.

In determination of the consistency in information (parameters), there is a case where the notification condition lists of two or more class modules has the same consistency with the information (such as vendor, product, driver name, class, subclass and protocol) of the connected external device 350. In this case, one most suitable class module (application) should be selected among the two or more class modules using the following method.

Specifically, as illustrated in the notification condition list 361 in FIG. 4, a priority parameter is added in the list. Therefore, in the above-mentioned case, the most suitable class module (application) is selected on the basis of the priority. For example, the priority parameter ranges from 0 to 99, and 50 is the basic point. In the above-mentioned case, one class module (application) having the highest priority among the two or more class modules is selected as the most suitable class module.

In addition, in order to determine the most suitable class module for the connected external device 350, it is possible to weight the parameters (such as vendor, product, driver name, class, subclass and protocol) of the external device. Specifically, the consistency of a class module (application) is determined on the basis of the total point thereof, which is calculated in consideration of the weight of the consistent parameter, and one class module (application) having a notification condition list with the highest total point is selected as the most suitable class module. For example, high priority is assigned to the parameters, vendor and product, medium priority is assigned to the parameter, driver name, and low priority is assigned to the parameters, class, subclass and protocol. By comparing the total points of the notification condition lists, the most suitable class module can be determined.

The notification condition list 361 used for determining the class module (application) 370 most suitable for the external device 500 causing the insertion/extraction event preferably has the newest information at the time the external device is connected with the multifunction product 100. Therefore, it is necessary for the multifunction product 100 to manage the notification condition list 361, for example, by updating the data of the notification condition list when the product is in a working state so that the product can correspond to newly connected external devices. Therefore, the class module 370 watches input of the notification condition information 371 to be registered on the notification condition list 361. When receiving input of the notification condition information 371, the class module 370 performs a processing of registering the notification condition information as needed.

For example, when installing an application used when the external device 500 is used, the class module 370 registers the information on the installed application on the notification condition list 361 at the same time. Specific examples of the method of installing an application include a method in which the application written in a medium is manually installed by an operator using the operating portion 201, and a method in which the application is automatically installed from the external device 500 connected with the multifunction product 100 through a network or a connector.

Thus, the class module 370 automatically registers data on the notification condition list 361 in this example.

In this regard, when the multifunction product 100 is in a power-off state, the retained notification condition list data are stored in a storage, and the stored notification condition list data are registered again to be used when the multifunction product achieves a power-on state.

The insertion/extraction detection module 360 determines the class module (application) 370 to be applied to the external device 350 connected to the multifunction produce 100 or the class module (application) 370, which has been applied to the external device 350 separated from the multifunction produce 100, using the notification condition list 361, which is managed as mentioned above. The insertion/extraction detection module 360 notifies the corresponding class module 370 about the determination results. Specifically, in this example, the insertion/extraction detection module 360 issues a notification event, which includes information concerning the kind of insertion/extraction events, the determined application, and other information needed for operating the external device 500, to the class module 370.

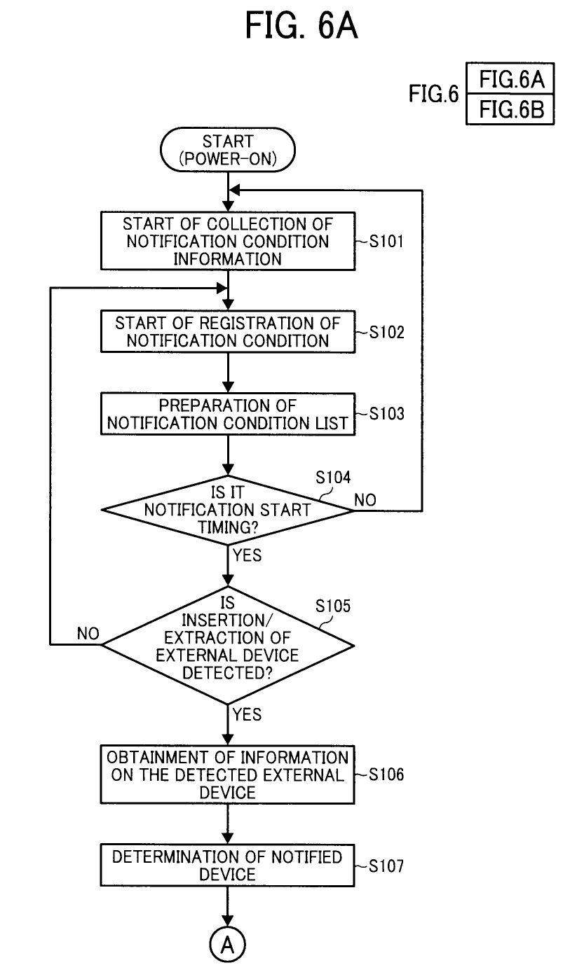

FIG. 5 is a view illustrating an example of the data construction of the notification event.

In the notification event illustrated in FIG. 5, the type of event means the kind (i.e., ATTACH or DETACH) of the insertion/extraction events. In addition, information needed for the class module (application), which is selected on the basis of the notification condition list 361, to access the corresponding external device 500 to establish a cooperative system is described in the notification event. In this example, data such as bus, address, cookie and driver name are added thereto. In this regard, the data, bus and address, are information needed for specifying the address of the external device 500, and the data, cookie, are unique ID used for identifying the external device 500. The data, driver name, are entry information on a usable device driver.

When the insertion/extraction detection module 360 cannot determine the class module (application) applicable to the connected external device 500 on the basis of the notification condition list and therefore decides that the external device cannot be used, the insertion/extraction detection module 360 notifies the user that the external device cannot be used.

When the general-purpose interface 350 is one (such as the USB host 243 illustrated in FIG. 1) directly connected with the multifunction product 100 and the USB memory 251 (illustrated in FIG. 1) is connected with the interface as an unusable external device 500, the information such that the external device cannot be used is conveyed to the user by a display device of a user interface 380 illustrated in FIG. 3. Specific examples of such a display device include the display device of the operation panel 201, and data interface lamps. In addition, such information can be conveyed to the user by printing out a message such that the external device cannot be used. In the case where an unusable external device is connected with the multifunction product 100 through a network, the information such that the external device cannot be used is conveyed to the user through the network, although it is not described in FIG. 3.

Next, the control flow will be explained.

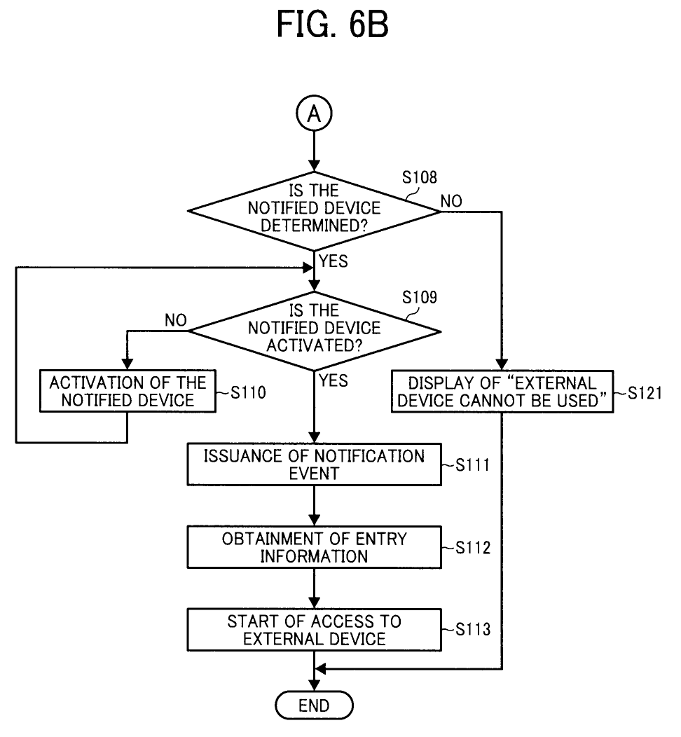

The operation of the class module selection control system illustrated in FIG. 3 will be explained by reference to the control flow illustrated in FIG. 6. The control flow illustrates the procedure of from power-on of the multifunction product 100 to start of access of the class module 370 to the connected external device 500. In addition, the control flow is also applicable to the case where the connected external device 500 is separated from the multifunction product 100. In this regard, the information flow concerning the steps of this control flow will be explained by reference to the view of the control system illustrated in FIG. 3. In FIG. 3, the information flow is shown by allows indicated by a number of from (1) to (8).

Referring to FIGS. 6 and 3, when the multifunction product 100 is turned on, the controller 200 thereof is initiated, the class module selection control system illustrated in FIG. 3 is activated, and the insertion/extraction detection module 360 and the class module 370 are also activated.

The activated class module 370 starts to collect notification condition information to register the information on the notification condition list 361 (step S101), and then requests the insertion/extraction detection module 360 to register the collected notification condition information (see flow (1) in FIG. 3), thereby starting registration of the notification condition (step S102). In this regard, it is preferable for the notification condition list 361 to retain the newest notification condition information. Therefore, whenever notification condition information to be registered is input, for example, by installing an application, a request for registering the information on the notification condition list 361 is made.

Next, the insertion/extraction detection module 360 prepares the notification condition list 361 (step S103) on the basis of the notification condition information received from the class module 370, and manages the prepared notification condition list, so that the information necessary for determining the suitable class module for the connected external device 500 can be provided. This information providing step will be explained later. In this regard, when the multifunction product 100 is turned on, the multifunction product performs an initialization processing of setting default data such as information, which is stored in a storage and which is inhibited from static overwriting. Namely, when the multifunction product 100 is turned on, information such that overwriting one or more of the parameters having a relatively high weight is inhibited is statically maintained in the external device information list.

After the notification condition list 361 is prepared in step S103, the application necessary for the multifunction product 100 achieving a power-on state is run, and a timer 390 determines whether or not the elapsed time from the initialization point, at which the product achieves an operable state in which an operation can be performed to fulfill the processing request, reaches the predetermined notification start time (step S104, see flow (4) in FIG. 3). The reason why this determination processing using the timer 390 is performed is that when a new external device is connected, the notification condition information 371 thereof is registered on the notification condition list 361 at the same time the connection is made, and if the registration processing delays, optimization in selection of the addressee (notified module) mentioned below cannot be performed. Therefore, in this determination processing using the timer 390, the notification start time is predetermined while considering delay in the registration processing.

When the elapsed time is shorter than the predetermined notification start time (NO in step S104), processings of from step S101 to step S104 are repeated until the elapsed time reaches the predetermined notification start time. By performing this procedure, occurrence of the above-mentioned problem due to delay of the registration processing can be prevented.

When the elapsed time reaches the predetermined notification start time (YES in step S104), the insertion/extraction detection module 360 determines whether or not the insertion/extraction of the external device 500 is detected through the insertion/extraction detection interface 351 (step S105).

In this regard, when the insertion/extraction of the external device 500 cannot be detected (NO in step S105), the processings of from step S102 to step S104 are repeated until the insertion/extraction of the external device 500 can be detected.

When the insertion/extraction of the external device 500 is detected (YES in step S105), information on the detected external device 500 is obtained (step S106). In this regard, when the insertion (attachment) of the external device 500 is detected, the device information 501 on the connected external device 500 is directly obtained through the general-purpose interface 350 (see flow (2) in FIG. 3). In addition, when the separation (detachment) of the external device 500 is detected, the device information 501 on the external device 500 is obtained from the management information stored when the external device is inserted (attached).

Next, the insertion/extraction detection module 360 compares the parameters (such as vendor, product, driver name, class, subclass and protocol) in the device information 501 with the parameters in the notification condition lists 361 (see FIG. 4) to determine the notification condition list having the highest consistency. The insertion/extraction detection module 360 determines the most suitable class module (application) 370 for the detected external device 500 on the basis of the application information in the notification condition list 361. The insertion/extraction detection module 360 determines the class module 370 as the addressee (i.e., the notified module) (step S107).

In step S107, there is a case where the addressee (i.e., the notified module) cannot be determined for such a reason that the device information 501 of the detected external device 500 is not present in the registered notification condition list 361. Therefore, in this example, it is confirmed whether or not the addressee can be determined (step S108) after step S107.

When the addressee (the notified module) is determined (YES in step S108), it is confirmed that the class module 370 to be notified is activated (step S109). This activation confirmation processing is necessary for an external device newly attached in the control flow when the multifunction product 100 is turned on. However, the activation confirmation processing is unnecessary for the case where the external device 500 is detached (because the class module 370 to be notified is already activated), and therefore step S109 can be omitted in this case.

This activation of the notified class module 370 relates to the communication device by which the notification event is issued in a later step. Since there is a resident process in general, the notification event is performed by an inter-process communication method in which the notification event is conveyed to the class module (application), which is already activated by the resident process. In this case, the notification event can be conveyed to the class module without newly activating an application. In this regard, the way to activate the resident process can be changed after shipment of the information processing apparatus (for example, at a time a class module is added).

However, it is not necessarily possible to perform the most suitable operation by designating the application, which is activated by a resident process, as the addressee of the notification event. It is possible to designate the application of the process to be used as the addressee of the notification event and to allow each of the installed processes to maintain a resident state while performing an inter-process communication in order to perform the most suitable operation. However, this method wastefully consumes the resources of the computer installed.

In contrast, this example uses the following method. Specifically, even when the application of the addressee is not a resident process and the process is not in a working state, the process is activated so that the most suitable operation can be performed. Since it is possible that the detection of connection of the external device 500 triggers to activate the process, the class module can be automatically activated, thereby saving the resources (such as CPUs and memories) of the computer installed when the external device is not connected. In addition, it is possible to additionally provide a mechanism for activating a class module, and thereby addition of a module can be easily performed.

Let's go back to the explanation of control flow in FIG. 6. When the class module (application) 370 to be notified is not activated (NO in step S109), the class module is activated (step S110). In this regard, the loop processing of from S109 to S110 is repeated until it is confirmed that the class module is activated. In this regard, it is possible to perform the activation of the class module 370 as one of the process activation operations.

After it is confirmed that the class module (application) 370 to be notified is activated (YES in step S109), the insertion/separation detection module 360 issues the notification event to the class module (see flow (5) in FIG. 3) in step S111.

When the kind of the insertion/separation event is insertion (i.e., ATTACH), the class module (application) 370 uses the application (driver name) attached to the notification event and the information (such as bus, address and cookie) needed for accessing the external device 500 for the operations of providing the external device 500 with services.

When the kind of the insertion/separation event is separation (i.e., DETACH), the operation of the class module (application) 370 is terminated.

The detailed procedure in the case where the kind of the insertion/separation event is insertion (i.e., ATTACH) is as follows. Specifically, the class module (application) 370 obtains the driver name described in the notification event received from the insertion/separation detection module 360 as entry information for accessing the connected external device 500 (step S112), and drives the driver of the external device 500, while using the driver name as entry.

In step S113, the driver of the class module (application) 370 for the external device 500 starts to access the function module 503 through a class interface 353 which is a general-purpose interface (see flows (6) and (7) in FIG. 3) by reference to the information (such as bus, address and cookie) needed for accessing the external device 500 described in the notification event.

Thereafter, this control flow is ended.

When the kind of the insertion/separation event is separation (i.e., DETACH), the steps S112 and 113 are not necessary and therefore the control flow is ended after issuance of the notification event in step S111.

After the addressee determining processing in step S107, it is confirmed whether the addressee (module to be notified) is determined (step S108). When the addressee is not determined (NO in step S108), it is determined that an unusable external device is detected. In this case, the insertion/separation detection module 360 orders the user interface 380 to display a warning message such that the corresponding external device 500 cannot be used (see flow (8) in FIG. 3). Upon receipt of the order, the user interface 380 performs a processing of notifying the user, for example, by displaying a message “The external device 500 cannot be used” in the display of the operating portion 201 (step S121). By displaying such a message that the external device cannot be used through the user interface 380, the usability of the information processing apparatus can be improved.

As mentioned above, in an information processing apparatus having limited resources (e.g., OS and memory of the computer) such as the computer-integrated apparatus mentioned above, by exclusively using a general-purpose driver, which is entry when accessing a variety of external devices, for the class module, it becomes possible to easily respond to the variety of external devices (including newly added external devices), which are connected or separated through general-purpose interfaces, without changing the structure of OS or installing a new driver, resulting in improvement of the convenience of the apparatus.

In the present invention, a computer program product is provided, which is stored on a computer readable storage medium for carrying out the above-mentioned method. In addition, a computer readable storage medium is provided, which stores computer instructions for performing the method mentioned above.

This document claims priority and contains subject matter related to Japanese Patent Application No. 2008-181556, filed on Jul. 11, 2008, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by letters patent of the United States is:

1. An information processing apparatus comprising:
a general-purpose interface configured to connect connectable and separable external devices to the information processing apparatus;
plural plug-in class modules configured to access the external devices through the general-purpose interface to provide the external devices with services;
a connection and separation detection module configured to detect connection or separation event of an external device; and
a list registration device, which has an external device information list, in which information on the connectable and separable external devices is stored while relating the information to the respective class modules, and which is configured to perform registration of new information in the external device information list as needed,
wherein the connection and separation detection module includes:
an external device information obtaining device configured to obtain information to specify the external device connected to the information processing apparatus;
a notified module determining device, which determines one of the plural class modules as a notified module on the basis of the information obtained by the external device information obtaining device and the information stored in the external device information list when detecting the connection and separation event of the external device; and
a device information notifying device configured to notify the corresponding class module about the information on the connected external device.

2. The information processing apparatus according to claim 1, wherein the connection and separation detection module further comprises:
a device configured to notify that the connected external device cannot be used through a user interface when the notified module determining device cannot determine the notified module.

3. The information processing apparatus according to claim 1, wherein the device information notifying device includes:
a device configured to run a program.

4. The information processing apparatus according to claim 1, wherein the device information notifying device includes:
a device configured to notify a resident process.

5. The information processing apparatus according to claim 1, wherein the notified module determining device starts to perform the determination processing a predetermined time after the information processing apparatus is turned on.

6. The information processing apparatus according to claim 1, wherein the information concerning the external devices stored in the external device information list includes parameters uniquely indicating the external devices and parameters indicating functions of the external devices, wherein the parameters are preliminarily weighted, and wherein the notified module determining device determines the notified module on the basis of the weighted parameters.

7. The information processing apparatus according to claim 6, wherein in the external device information list, information such that overwriting one or more of the parameters is inhibited is statically maintained.

8. The information processing apparatus according to claim 1, wherein the information concerning the external devices stored in the external device information list includes information concerning priority of the class modules, and wherein the notified module determining device determines the notified module on the basis of the priority information.

9. A method for controlling activation of a class module in an information processing apparatus including plural plug-in class modules configured to access connectable and separable external devices through an interface to provide the external devices with services, said method comprising:
storing new information as needed in an external device information list in which information on the connectable and separable external devices is stored while relating the information to the respective class modules;
detecting connection or separation event of an external device;
obtaining information to specify the external device connected to the information processing apparatus;
determining one of the plural class modules as a notified module on the basis of the information obtained in the external device information obtaining step and the information stored in the external device information list when detecting the connection and separation event of the external device; and
notifying the corresponding class module about the information on the connected external device.

10. The method according to claim 9, further comprising:
notifying that the connected external device cannot be used through a user interface when the notified module cannot be determined in the notified module determining step.

11. The method according to claim 9, wherein in the notifying step, the information notification is performed while program initiation is performed.

12. The method according to claim 9, wherein in the notifying step, the notified class module is a resident process.

13. The method according to claim 9, wherein the notified module determining step starts a predetermined time after the information processing apparatus is turned on.

14. The method according to claim 9, wherein in the information storing step, the information concerning the external devices stored in the external device information list includes parameters uniquely indicating the external devices and parameters indicating functions of the external devices, wherein the parameters are preliminarily weighted, and wherein in the notified module determining step, the notified module is determined on the basis of the weighted parameters.

15. The method according to claim 14, wherein in the information storing step, information such that overwriting one or more of the parameters is inhibited is statically maintained in the external device information list.

16. The method according to claim 9, wherein the information concerning priority of the class modules stored in the external device information list concerning the external devices includes information, and wherein in the notified module determining step, the notified module is determined on the basis of the priority information.

17. A computer program product stored on a computer readable storage medium for carrying out the method according to claim 9.
